(19) United States
(12) Patent Application Publication
(10) Pub. No.: US 2012/0167347 A1
(43) Pub. Date: Jul. 5, 2012

(54) NATURAL SANITARY HANDLE COVERS

(76) Inventor: Dini Bigajer, Brooklyn, NY (US)

(21) Appl. No.: 12/982,038

(22) Filed: Dec. 30, 2010

(51) Int. Cl. B25G 1/00; A41D 19/015

(52) U.S. Cl. 16/422; 2/159

(57) ABSTRACT

A sterile disposable cover for a handle or lever or knob of a fixture which includes a hollow member defining an interior and being comprised of bamboo sheet material and having at least one opening into said interior to receive said handle or lever of said fixture; an elastic member threaded through the bamboo fabric and suitable for either closing off the opening and/or tightening the opening around a surface of the handle or lever of the fixture; and wherein said bamboo sheet is formed and configured to provide an outer sterile surface which is phobic to germs and other microbial living organisms. Preferably, the bamboo sheet is constructed as a non-woven web of bamboo fibers.

### BACKGROUND OF THE INVENTION

The present invention is directed to anti-germ, anti-microbial, protective coverings that prevent the spread of disease and, more particularly, to fabric-like coverings adapted for use on doorknobs, door handles, bathroom levers and the like.

The spread of news among the public of new strains of microbes in hospitals and other public places has resulted in a dramatic increase in the public's desire for providing protection against the spread of infectious disease from person to person through the successive touching of door handles, doorknobs, bathroom levers, faucets and the like in public places. Infectious diseases are now the third leading cause of death in the United States. The spread has also heightened, due to the increase in travel and the resultant multiple use of the same equipment by a large number of people.

Types and seriousness of communicable diseases transmitted in this manner are varied. Viral and bacterial disease alike can be communicated by physical contact with surfaces upon which the infectious agents reside. Further, there is an increasing awareness and concern worldwide of the possibility of widespread outbreaks, or even pandemics of communicable diseases. These concerns stem in part from possible spontaneous mutation of influenza and other viruses, as well as increasing resistance of bacterial strains to conventional, even newly developed antibiotics.

This well known problem has been addressed by numerous individuals, as reflected by a very large body of prior art that has developed in relation thereto. In accordance with this prior art, various fabrics or material webs are applied to the grasping surfaces of doorknobs, etc., with the fabric or web being impregnated with an anti-microbial, anti-germ agent. Thus, the prior art proceeds with the idea that successive touching of the impregnated coverings or the providing of constantly replaced coverings, will protect the public from disease being spread from one person to another.

The mentioned prior art describes pocket-like coverings in different shapes and forms that slip snugly over the doorknob and/or more elongated, generally cylindrical fabric tubes or sleeves that fit over door handles, designed to protect against the spreading of germs and other bacteriological agents. Representative of this prior art is U.S. Statutory Invention Registration No. H2123 H dated Jan. 3, 2006 which discloses a pocket-like cover for doorknob. It is intended to carry an anti-bacteriological medium that destroys bacteria transferred from a hand to a doorknob.

U.S. Pat. No. 2,781,220 dated Feb. 12, 1957, discloses a pocket-like cover for a doorknob, and provides a cord 12 (see column 2) which allows the pocket to be tightened on the inside end of the doorknob.

U.S. Pat. No. 4,856,140 dated Aug. 15, 1989 describes a sanitary handle cover which has a pocket-like structure, which can be configured either for a doorknob or the handle of a toilet seat and which also comes with a ring 22 with a strap or a band with elastic to close one side.

U.S. Pat. No. 5,713,615 dated Feb. 3, 1998 is directed to a stretchable doorknob cover which, once again, has a string laced through the neck of the doorknob cover, so it can be tightened on the doorknob.

Other examples of doorknob covers are provided in U.S. Pat. No. 5,840,122 dated Nov. 24, 1998 and in U.S. Pat. No. 5,008,551 dated Apr. 16, 1991.

A decorative doorknob cover is disclosed in U.S. design patent no. DES 427,046 dated Jun. 27, 2000, which also has a band to secure it in place.

U.S. Pat. No. 4,832,942 dated May 23, 1989 describes a material impregnated with antibacterial material and which can be cut into different shapes, as shown in FIGS. 7 and 8 of this patent. The sheet is glued to the doorknob and then tied around it. It is described as being able to fit doorknobs, toilet seat operating mechanisms and the like.

U.S. Pat. No. 6,546,594 dated Apr. 15, 2003 is directed to sanitary and disposable covers for doorknobs and door handles and shows, in FIG. 3, a sleeve-like structure, either end of which can be closed with an elasticized or rubberized ring 24 or retaining ring 30, as described in column 4 of this patent.

U.S. Pat. No. 6,560,335 dated May 6, 2003 also shows a very similar product for use over a telephone, rather than a doorknob.

See also, U.S. Pat. No. 5,215,319 dated Jun. 1, 1993 which shows a sanitary cover for shopping cart handles. U.S. Pat. No. 4,976,299 dated Dec. 11, 1990 shows a sterile disposable cover for a cylindrical handle generally.

Other patents provide mechanical means for dispensing disinfectant and protecting handles. Representative of these patents are U.S. Pat. No. 4,046,508 dated Sep. 6, 1977; U.S. Pat. No. 5,938,069 dated Aug. 17, 1999; U.S. Pat. No. 1,493,557 dated May 13, 1924; U.S. Pat. No. 4,997,139 dated Mar. 5, 1991; and U.S. Pat. No. 7,598,501 dated Oct. 6, 2009.

Nonetheless, the known prior art still leaves open the issue of the inconvenience and unreliability in affixing such pocket-like covers to the door handles, doorknobs and the like, and the fact that these coverings require to be impregnated with special agents, some of which present a tacky or wet feel or which may dry up or lose their effectiveness over time.

### SUMMARY OF THE INVENTION

It is the object of the present invention to provide doorknob, door handle and like coverings that prevent the spread of diseases, in configurations which are easy to use and effective in accomplishing their purposes, without requiring special anti-germ and anti-bacteriological agents.

It is another object of the present invention to provide a disease-spreading, preventing covering which uses entirely natural, preferably non-woven webs or sheets, to form the pocket-like or elongate coverings.

The foregoing and other objects of the invention can be realized in accordance with the present disclosure in the form of a sterile disposable cover for a handle or lever or knob of a fixture, wherein the disposable sterile cover includes a hollow member defining an interior and being comprised of bamboo sheet material and having at least one opening into said interior to receive said handle or lever of said fixture; an elastic member threaded through the bamboo fabric and suitable for either closing off the opening and/or tightening the opening around a surface of the handle or lever of the fixture; and wherein said bamboo sheet is formed and configured to provide an outer sterile surface which is phobic to germs and other microbial living organisms. The sterile disposable cover can include a band located near the opening and slidable over the elastic to conceal it. For door handles or toilet seat levers, the shape of the cover is more elongate with openings at either one side only or at both sides, with an ability to tighten the openings against the lever or knob of the fixture. Preferably, the sterile disposable cover is made of non-woven web of bamboo fibers.

In accordance with different embodiments of the invention, the cover can assume different shapes, such as a pocket-like shape or an elongate shape, or a glove shape, or even as a simple sheet with a tacky surface that can be adhered to the push plate on a swinging door. The same sheet can be wrapped around the tubular push bar of a shopping cart. In accordance with another embodiment, the longitudinal length of the cover can be extended, owing to an inwardly folded portion that can be slowly pulled apart. The inside surface can be treated with a light adhesive for better contact and frictional engagement with the lever or the doorknob.

Other features and advantages of the present invention will become apparent from the following description of the invention which refers to the accompanying drawings.

### BRIEF DESCRIPTION OF THE DRAWINGS

FIG. 1A illustrates a prior art doorknob.

FIG. 1B shows a covering for the doorknob of FIG. 1A in accordance with the present invention.

FIG. 1C shows another perspective view of the covering for a doorknob, shown in FIG. 1B.

FIG. 1D shows a similar covering with a protective band.

FIG. 2 shows a flat covering which can be rolled around a tube, for example, the push bar of a shopping cart, or affixed via a tacky glue to a push plate of a door.

FIG. 3 shows a cylindrical covering in accordance with the present invention.

FIG. 4 shows a variant of the covering of FIG. 3.

### DETAILED DESCRIPTION OF EMBODIMENTS OF THE INVENTION

An important aspect of the protective coverings of the present invention resides in its use of a natural, bio-degradable bamboo fiber, web or sheet, which is preferably non-woven, in order to construct the various sterile coverings in accordance with the present invention.

It has been recognized by the instant inventor that the utilization of the non-woven, bamboo fabric web presents a sterile and germ phobic surface on which germs and other microbes do not survive and on which they do not propagate and multiply. By being non-woven, they do not contain the interstitial spaces in which dampness or a wet environment would be established for microbes to live and thrive in. The flat surface is hostile to the microbes and even after it is touched by a human hand, the germs would not stay on it, so that the next user of the covering on the doorknob would not encounter microbes and other germs that would otherwise migrate from the covering to his or her hand.

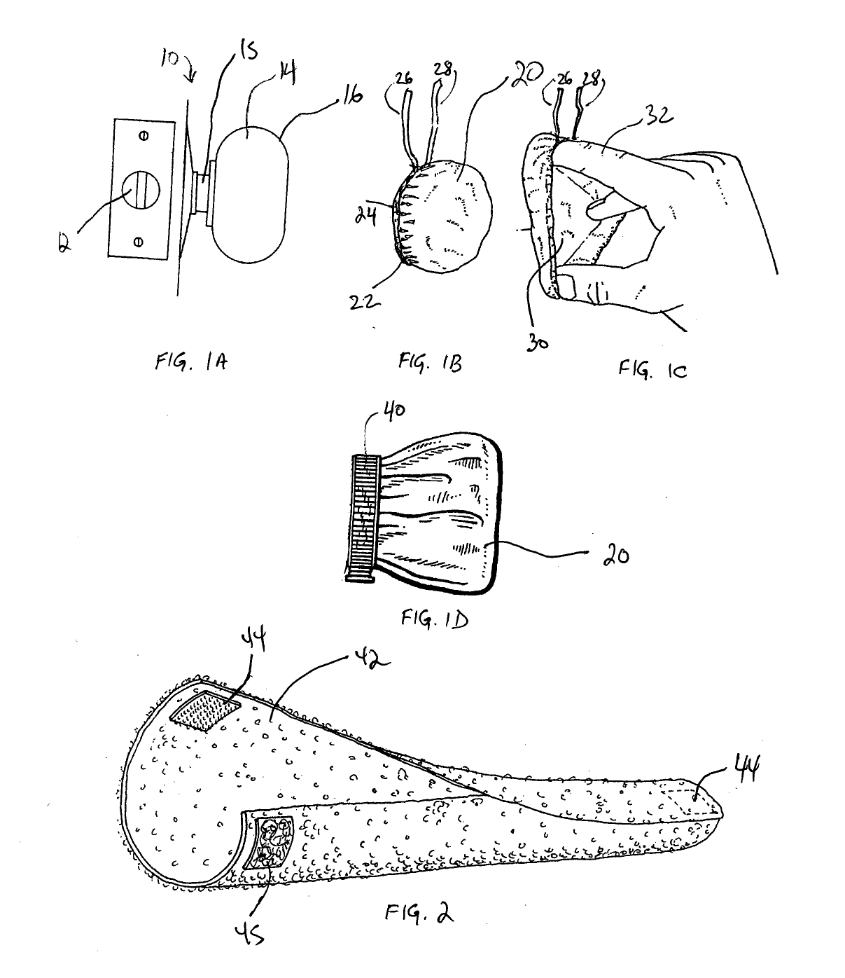

Referring to the figures, FIG. 1A shows a door 10, with its latch 12 supporting the doorknob 14, that has the grasping surface 16. The bamboo web covering 20 shown in FIG. 1B is constructed from generally flat and circular material that is gathered at the free edge 22 and through which is threaded a string or elastic 24 (preferably made of non-woven material) which has two free string ends 26, 28 which meet at one end. When the interior 30 is grasped with the fingers 32 and slipped over the doorknob 14, the strings ends 26, 28 are tied around the stem 15. To avoid the look of loose string, FIG. 1D also shows a band 40 which can be slipped around the string 24 and tightened so as to present a very neat appearance.

Turning to FIG. 2, a flat sheet 42 of the same bamboo web can be used in several modes, including in one mode where the underside is treated with a very light adhesive or tacky material, which allows the bamboo sheet 42 to be placed on and adhered to a flat pushing plate on swinging doors or the like, as found in many public buildings. Alternatively, the generally rectangular bamboo sheet 42 can be wrapped around the tubular handle of a shopping cart (not shown) in a supermarket or the like, to similarly protect against the transfer of germs from user to user. Velcro® pads 44, 45 at opposed ends will maintain the sheet 42 tightly around the shopping cart handle.

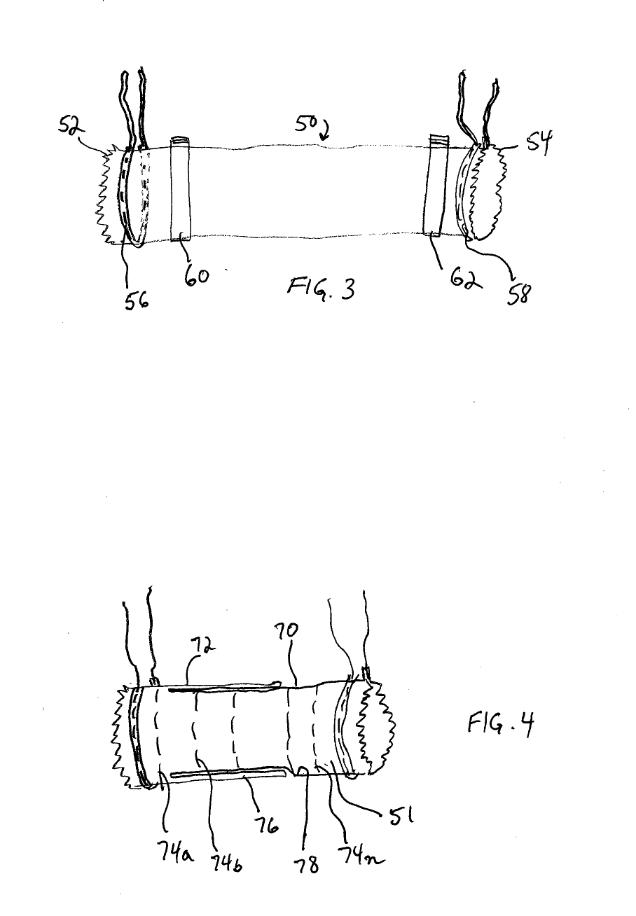

The bamboo sheet, naturally sterile covering of the present invention can be provided in different shapes and configurations. Thus, as illustrated in FIG. 3, the sheet can be fabricated in the form of an elongate tube 50 which is open at opposed ends, with the ends 52, 54 being provided with similar threaded-through strings 56, 58 and with respective bands 60, 62 that can be slipped laterally to conceal the string as previously described. Thus, the covering of FIG. 3 is more suitable for a door handle (not shown) which can be pushed/pivoted up and down to open the door, in well known manner.

Other shapes of the bamboo covering can also be provided. For example, for personal use, a cover in the shape of a glove can be utilized by donning it whenever needed and then storing it in one's pocket or pocketbook, inasmuch as, even if germs were to have been present on the door handle, they would not survive on the natural bamboo sterile surface. Although the coverings can be used and reused several times, it is advisable that in public places such as supermarkets and office buildings and the like the covering be changed from time to time, to avoid dirt gathering thereon and forming a living medium for bacteria, germs and other organisms.

The tubular elongate covering of FIG. 4 is a modified version of FIG. 3, where one portion of the tube is inwardly folded, which allows the folded over portions 70, 72 to be pulled out to lengthen the size of the tube so that it can be fitted and matched to different door handle lengths. Indeed, the body 51 can have a series of elastics 74a, 74b-74n running through it, to shrink its diameter, to more tightly fit around handles of different diameters, or even allow its placement over toilet actuating levers and the like. A lightly holding adhesive layer 76 may be provided between the overlapped portions 70, 72. Indeed, in another embodiment, the entire inner surface 78 may be coated with a tacky layer to improve its holding frictional force over the door handle, but without impeding the ability to slide the covering over the door handle.

Thus, unlike the prior art, no insecticides are necessary in the coverings of the present invention, avoiding any dampness or wetness feeling and also dispensing with the need to use gels such as Purel® and the like to get the mental comfort of being protected from the spread of germs when operating doorknobs or door handles and the like in public buildings.

Although the description above mentioned the preference that the sheet material be non-woven bamboo, the invention is not limited to non-woven bamboo web, but may be used even with woven bamboo fabric, although that expedient is deemed to be not as effective as using the non-woven bamboo sheets. The utilization of the elastic to tighten around the covered object and the concurrent use of a tape to conceal it provides an aesthetic aspect of the invention.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. Sterile disposable cover for a handle or lever or knob of a fixture, said cover comprising:
a hollow member defining an interior and being comprised of bamboo sheet material and having at least one opening into said interior to receive said handle or lever of said fixture;
an elastic member threaded through the bamboo fabric and suitable for either closing off the opening and/or tightening the opening around a surface of the handle or lever of the fixture; and
wherein said bamboo sheet is formed and configured to provide an outer sterile surface which is phobic to germs and other microbial living organisms.

2. The sterile disposable cover of claim 1, further including a band located near the opening and slidable over the elastic to conceal the same.

3. The sterile disposable cover of claim 1, including a first opening at one end and a second opening into said interior at another end, each opening including a respective elastic which is configured to either close off or to tighten the opening to the fixture.

4. The sterile disposable cover of claim 1, wherein said bamboo sheet is constructed as non-woven web of fibers.

5. The sterile disposable cover of claim 1, wherein said bamboo sheet is constructed a woven fabric.

6. The sterile disposable cover of claim 4, wherein said cover is constructed to have a pocket-like shape which can be fitted over and tightened around a bulbous doorknob.

7. The sterile disposable cover of claim 4, wherein said cover is constructed in the form of an elongate tube which has said at least one opening on opposite sides thereof and which is configured to be slipped over a door handle.

8. The sterile disposable cover of claim 4, wherein said cover is constructed in the form of a generally rectangular sheet and includes a tacky surface at one surface thereof which enables it to be adhered to a metallic or wooden push plate on a swinging door or the like.

9. The sterile disposable cover of claim 8, wherein said rectangular cover is foldable into a tubular shape around a tubular push bar of a shopping cart.

10. The sterile disposable cover of claim 9, wherein said cover comprises Velcro® hook and eye strips so that the cover can be securely wrapped over a tubular bar.

11. The sterile disposable cover of claim 4, wherein said elongate body comprises elastic strings, one end of which are biased to reduce an inner diameter of the interior.

12. The sterile disposable cover of claim 11, wherein said elastic strings are fastened to an interior surface of the cover.

13. The sterile disposable cover of claim 1, wherein said cover is formed in a shape of a glove that fits over a person's hand.

14. The sterile disposable cover of claim 4, wherein said elongate cover has an overlapped portion and the cover can be pulled at opposing ends to change the length of the cover to more precisely fit door handles of different lengths.

15. The sterile disposable cover of claim 1, including a tacky adhesive applied to an interior surface of the hollow member to promote its adhesion to the handle or lever or knob of the fixture.
